(19) United States
(12) Patent Application Publication
(10) Pub. No.: US 2024/0078293 A1
(43) Pub. Date: Mar. 7, 2024

(54) DEVICE, SYSTEM, AND METHOD FOR AUTHENTICATING OWNERSHIP OF MEDIA

(71) Applicant: Collectors Universe, Inc., Santa Ana, CA (US)

(72) Inventors: John Nelson, Trabuco Canyon, CA (US); Deniz Kahn, Costa Mesa, CA (US)

(21) Appl. No.: 18/458,826

(22) Filed: Aug. 30, 2023

Related U.S. Application Data
(60) Provisional application No. 63/374,468, filed on Sep. 2, 2022.
(60) Provisional application No. 63/482,423, filed on Jan. 31, 2023.

(51) Int. Cl. G06F 21/10

(52) U.S. Cl. CPC G06F 21/1064; G06F 21/1015

(57) ABSTRACT

A device for authenticating ownership of media includes a storage case configured to store and protect a media product. The media product includes unique content. An identification module is associated with the storage case. The identification module stores a unique identification code used to identify the media product and an owner of the media product. A transmitter transmits the unique identification code. The transmission of the unique identification code is used to authenticate ownership of the media product to allow the owner to access the unique content of the media product without removing the media product from the storage case.

### CROSS-REFERENCE TO RELATED APPLICATION

This is a regular utility application of provisional Ser. No. 63/374,468, filed Sep. 2, 2022, and provisional Ser. No. 63/482,423, filed Jan. 31, 2023, the contents of each of which are expressly incorporated herein by reference.

### FIELD

The present disclosure relates to ownership of media and, more particularly, to a device, system, and method for authenticating ownership of media.

### BACKGROUND

Preservation of collectables, valuables, and sentimental objects have been ongoing for years. One form of physical media preservation is to encase a physical disk or other embodied form of the media in a physical case that encapsulates the physical media to prevent degradation or damage of the physical media, and to physically associate a quality grade with the media. However, encapsulating physical media, or any collectable, in such a case prevents the owner from accessing the media after the media has been encapsulated to enjoy or use the encased product.

### SUMMARY

One of the common refrains from those opposed to grading and authentication of collectible media, such as video games, is “games are meant to be played.” Aspects of the present disclosure enable an encapsulated and stored media product to continue to be used, even after the media product has been encapsulated and protected in a storage case. Encapsulation is often performed when a media product, such as a video game, is graded to indicate its quality of the condition of the media product. For example, an unopened video game in its original packing and in pristine condition may receive a high score, while an open video game that has been previously used but is in excellent condition and includes the original packaging may receive a high, relatively speaking, but somewhat different grading score. Aspects of the present disclosure also provide a process for storing an encapsulated and stored media product in a vault, while continuing to allow a user to verify ownership of the media product and access the contents of the media product.

Provided in accordance with aspects of the present disclosure is a device for authenticating ownership of media including a storage case configured to store and protect a media product. The media product includes unique content. An identification module is associated with the storage case. The identification module stores a unique identification code used to identify the media product and an owner of the media product, which can be an individual or a juridical entity. The unique identification code can include both human readable information and machine readable information. The machine readable information can include a transmitter to transmit the unique identification code. The transmission of the unique identification code can be used to authenticate ownership of the media product to allow the individual owner to access the unique content of the media product without removing the media product from the storage case.

In an aspect of the present disclosure, the storage case includes a rating banner indicative of a quality rating for the media product. In an example, an original, un-opened media package, can be preserved in a storage case in accordance with aspects of the present disclosure.

In an aspect of the present disclosure, the identification module includes an NFC chip, an RFID tag, a FPGA, or a NFT. The NFC device may be programmed to wirelessly transmit data associated with the card to a device programmed to receive the transmission. For example, an EEPROM chip may be sealed in a package with the media, and may be read by an NFC tag reader, which may retrieve a unique identifier for the media along with some metadata about the media. In other examples, the identification module includes a barcode for use with a barcode scanner to query a database using the barcode that is scanned to retrieve metadata that is associated with the unique identifier of the media. In another example, a Quick Response (QR) code is used to retrieve metadata that is associated with the unique identifier of the media.

In an aspect of the present disclosure, the media product is a video game, an audiovisual product, an audio recording, a video recording, a written work, a comic book, a collectible card, a playable card, a sports card, or another software media product.

In an aspect of the present disclosure, the storage case can dock with a user interface device. The user interface device facilitates the owner consuming the unique content of the media product.

In an aspect of the present disclosure, the storage case is configured to communicate with a user interface device through a wired or wireless connection to facilitate the owner consuming the unique content of the at least one media product by using the user interface device.

In an aspect of the present disclosure, a receiver is configured to receive data at the storage case. The receiver is configured to receive data through a wired or wireless connection.

In an aspect of the present disclosure, the storage case includes a port configured to transmit data from the storage case or receive data at the storage case.

In an aspect of the present disclosure, the storage case includes a battery, such as a rechargeable battery, that powers the storage case.

In an aspect of the present disclosure, the port is a USB-C port configured to recharge the rechargeable battery.

Provided in accordance with aspects of the present disclosure is a device for authenticating ownership of media including a user interface in communication with the storage case. The user interface includes a screen and a controller.

In an aspect of the present disclosure, the user interface is embodied in the storage case.

In an aspect of the present disclosure, the user interface is a separate device from the storage case. The storage case is configured to communicate with a user interface device through a wired or wireless connection to facilitate the owner consuming the unique content of the at least one media product by using the user interface device.

Provided in accordance with aspects of the present disclosure is a device for displaying media including a media display assembly including a receiver. The receiver is configured to receive a unique identification code from the storage case storing and protecting a media product. The storage case includes a transmitter configured to transmit the unique identification code to the receiver of the media display assembly. Transmission of the unique identification code to the receiver of the media display assembly is used to authenticate ownership of the media product. Authenticating ownership of the media product permits the media display assembly to allow the owner to access the unique content of the media product without removing the media product from the storage case.

In an aspect of the present disclosure, a screen is in communication with the media display assembly. The screen is configured to display the unique content of the media product. A controller is in communication with the media display assembly. The controller facilitates the owner of the media product interacting with the unique content of the media product displayed on the screen.

In an aspect of the present disclosure, a screen is embodied in the media display assembly and the media display assembly is portable.

In an aspect of the present disclosure, the portable media display assembly is configured to connect with another device configured to display the unique content of the media product.

In an aspect of the present disclosure, the media display assembly is configured to communicate with the screen or the controller through a wired or wireless connection.

In an aspect of the present disclosure, the media display assembly may include a controller port configured to provide a wired connection between the controller and the media display assembly. The media display assembly may include an output port configured to provide a wired connection between the screen and the media display assembly.

In an aspect of the present disclosure, a receiver is configured to receive data at the media display assembly. The receiver is configured to receive data through a wired or wireless connection.

In an aspect of the present disclosure, the media display assembly includes a port configured to transmit data from the media display assembly or receive data at the media display assembly.

In an aspect of the present disclosure, the media display assembly may include a battery, such as a rechargeable battery, for powering the media display assembly.

In an aspect of the present disclosure, the port of the media display assembly may be a USB-C port configured to recharge the rechargeable battery or to transmit/receive data from or at the media display assembly.

Provided in accordance with aspects of the present disclosure is a system for authenticating ownership of media including a transmitter associated with the storage case. The transmitter is configured to transmit the unique identification code. A server is configured to communicate with the transmitter to receive the unique identification code to authenticate ownership of the media product to allow the owner to access the unique content of the media product without removing the media product from the storage case.

In an aspect of the present disclosure, the server is a cloud server.

In an aspect of the present disclosure, the system includes an emulator configured to display the unique content of the media product.

In an aspect of the present disclosure, the emulator is stored on a smartphone, tablet computer, personal computer, or a media display assembly.

In an aspect of the present disclosure, the emulator is accessed through a web browser.

In an aspect of the present disclosure, the system includes a database of ROM files in communication with the server. A user interface includes an emulator configured to display the unique content of the media product using one of the ROM files.

Provided in accordance with aspects of the present disclosure is an identification module associated with the storage case. The identification module stores a unique identification code used to identify the media product and an owner of the media product. A device configured to display the unique content of the media product includes an identification code reader. The identification code reader is configured to read the unique identification code to authenticate ownership of the media product to allow the device to display the unique content of the media product without removing the media product from the storage case.

Provided in accordance with aspects of the present disclosure is a system for authenticating ownership of media including a first storage case configured to store and protect a media product including unique content. A first identification module associated with the first storage case stores a first unique identification code used to identify the media product and an owner of the media product. A first transmitter associated with the first storage case transmits the first unique identification code. A server in communication with the first transmitter receives the first unique identification code. A second storage case is configured to store and protect a media console. The media console is configured to interface with the media product to display the unique content of the media product. A second identification module associated with the second storage case stores a second unique identification code used to identify the media console and an owner of the media product. The owner of the media product is the same owner as the owner of the media console. A second transmitter associated with the second storage case transmits the second unique identification code to the server. Transmission of the first unique identification code and the second unique identification code to the server is used to authenticate ownership of the media product and to authenticate ownership of the media console to allow the owner to access the unique content of the media product without removing the media product from the first storage case and without removing the media console from the second storage case.

In an aspect of the present disclosure, the first identification module includes an NFC chip, an RFID tag, a FPGA, or a NFT, and the second identification module includes an NFC chip, an RFID tag, a FPGA, or a NFT.

Provided in accordance with aspects of the present disclosure is a method of authenticating ownership of media including receiving a media product and storing the media product in a storage case to protect the media product. A unique identification code identifying an owner of the media product stored in the storage case is generated. The unique identification code is transmitted to authenticate the owner of the media product stored in the storage case.

In an aspect of the present disclosure, the method includes allowing the owner of the media product to access the unique content of the media product without removing the media product from the storage case.

In an aspect of the present disclosure, the method includes grading the media product to generate a quality rating for the media product and displaying the quality rating on the storage case.

In an aspect of the present disclosure, generating the unique identification code includes generating a NFT authenticated using a blockchain.

In an aspect of the present disclosure, the storage case holding the media product may be transferred to a storage vault. The owner of the media product may be allowed to access the unique content of media product without removing the storage case storing the media product from the storage vault.

Provided in accordance with aspects of the present disclosure is a method of authenticating ownership of media including creating a digitized copy of the media product including the unique content of the media product before storing the media product in a storage case.

### BRIEF DESCRIPTION OF THE DRAWINGS

Various aspects and features of the present disclosure are described hereinbelow with reference to the drawings wherein:

FIG. 1 is a diagram of a device for authenticating ownership of media according to aspects of the present disclosure;

FIG. 2 is a diagram of a device for authenticating ownership of media configured to dock with a device for displaying the media according to aspects of the present disclosure;

FIG. 3 is a diagram of a device for authenticating ownership of media including a display screen and controller according to aspects of the present disclosure;

FIG. 4 is a diagram of a media display assembly according to aspects of the present disclosure;

FIG. 5 is a diagram of another media display assembly according to aspects of the present disclosure;

FIG. 6 is a diagram of a system for authenticating ownership of media according to aspects of the present disclosure;

FIG. 7 is a diagram of another system for authenticating ownership of media according to aspects of the present disclosure;

FIG. 8 is a diagram of a cloud server according to aspects of the present disclosure;

FIG. 9 is a diagram of another system for authenticating ownership of media according to aspects of the present disclosure;

FIG. 10 is a diagram of a system for displaying authenticated media according to aspects of the present disclosure;

FIG. 11 is a diagram of another system for displaying authenticated media according to aspects of the present disclosure;

FIG. 12 is a flow chart of a method for authenticating ownership of media according to aspects of the present disclosure;

FIG. 13 is a flow chart of another method for authenticating ownership of media according to aspects of the present disclosure;

FIG. 14 is a flow chart of another method for authenticating ownership of media according to aspects of the present disclosure;

FIG. 15 is a flow chart of another method for authenticating ownership of media according to aspects of the present disclosure; and

FIG. 16 is a block diagram of an exemplary computer employable by the device, system, and method described herein according to aspects of the present disclosure.

### DETAILED DESCRIPTION

Descriptions of technical features or aspects of an exemplary configuration of the disclosure should typically be considered as available and applicable to other similar features or aspects in another exemplary configuration of the disclosure. Accordingly, technical features described herein according to one exemplary configuration of the disclosure may be applicable to other exemplary configurations of the disclosure, and thus duplicative descriptions may be omitted herein.

Exemplary configurations of the disclosure will be described more fully below (e.g., with reference to the accompanying drawings) Like reference numerals may refer to like elements throughout the specification and drawings.

Traditionally, preserved media can be encapsulated in an airtight, tamper-proof, or tamper-evident storage case (e.g., at the time of grading) to preserve the media, including preserving un-opened original packaging in the tamper-evident storage case. However, conventional encapsulation of such media prevents the owner of the media from having access to the unique content of that media.

With respect to encapsulated video games, the content of such video games can often be accessed through forming a ROM file that can be played using an emulator to access the content of the video game without being in physical possession of the video game.

A ROM file is a computer file containing a copy of the data from a read-only memory chip (e.g., a video game cartridge). A ROM file can contain a computer's firmware, or the data from an arcade game's main board. A ROM file is often used in the context of emulation, in which games or firmware are copied to ROM files which can be made accessible using a piece of software known as an emulator. The emulator is generally run on a different device from a device which would have initially run the video game (e.g., a video game console). ROM burners/readers (readers may also be referred to as “dumpers”) can be employed to copy ROM data to hardware, such as ROM cartridges, or ROM chips, or for transmitting video game data to a server (e.g., a cloud server) to store the dumped ROMS in a database for later access or download. As an example, an opened video game presented by an owner of the opened video game could be employed to generate a ROM file for the video game. Alternatively, a database of previously made ROM files could be made accessible to an owner of a video game without generating a new ROM each time a new iteration of a video game is encapsulated.

Similar to the use of ROM files, optical disc-based games can also be digitized, and these are typically stored as an image most often in an ISO format. The digitized optical-based game can similarly be made available to a user via emulation after the identity of the owner and ownership of a particular media product has been authenticated.

The transmitters/receivers described herein may facilitate wireless communication by a WiFi, Bluetooth®, or cell tower connection to provide/receive data between the storage case and another computer. Thus, the transmitters/receivers described herein facilitate internet access for any associated device, allowing access to remote computer servers, such as cloud servers to transmit/receive data to/from the remote computer servers. The transmitters/receivers described herein facilitate wireless connectivity that is compatible with Internet of things (IoT) connectivity. The transmitters/receivers described herein may allow for wired or wireless connections to other devices, or systems, such as other computer systems (e.g., systems including one or more servers, such as cloud-based servers).

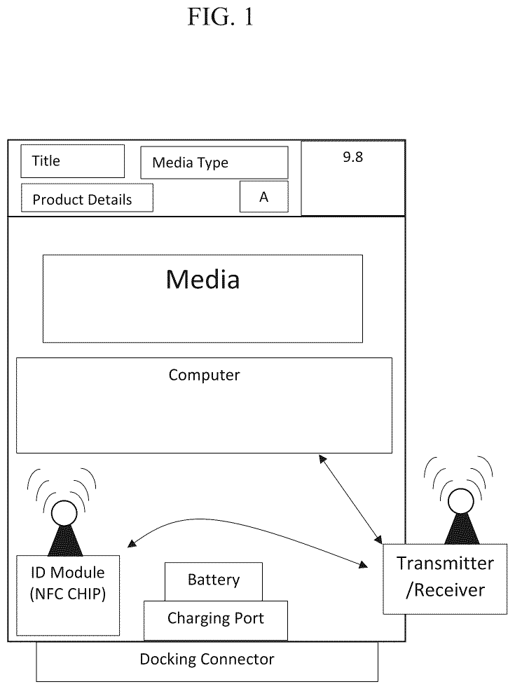

Referring particularly to FIG. 1, a device is shown for authenticating ownership of media including a storage case configured to store and protect a media product. The media product includes unique content. The storage case is used to encapsulate and store the media for preservation. The storage case may include a rating banner (e.g., a printed or digitally displayed banner) indicative of a quality rating for the media product. The storage case can include a computer including a processor, a memory, and a hard drive, that can be employed for executing the various algorithms described herein.

The storage case includes a transmitter/receiver that can communicate with the computer and/or a remote computer, such as a computer server (e.g., a cloud server). The transmitter/receiver may wirelessly communicate the identification codes described herein.

The storage case may include a battery, such as a rechargeable battery and a charting port for charging the battery. The charging port may also be a data transfer port, such as a USB-C type port. The storage case may include tamper proof or tamper resistant features, such as irreversible internal detents that cannot separate once engaged, sonic welding, bonding, or combinations thereof. The storage case may further include compartments or sections for separately positioning the contents inside. For example, a first compartment can have a first window for accommodating a media and a second compartment for accommodating identification materials. Surface features may be included for various functions, such as for stacking, for displaying, and for coupling to another device, such as when docking to another device.

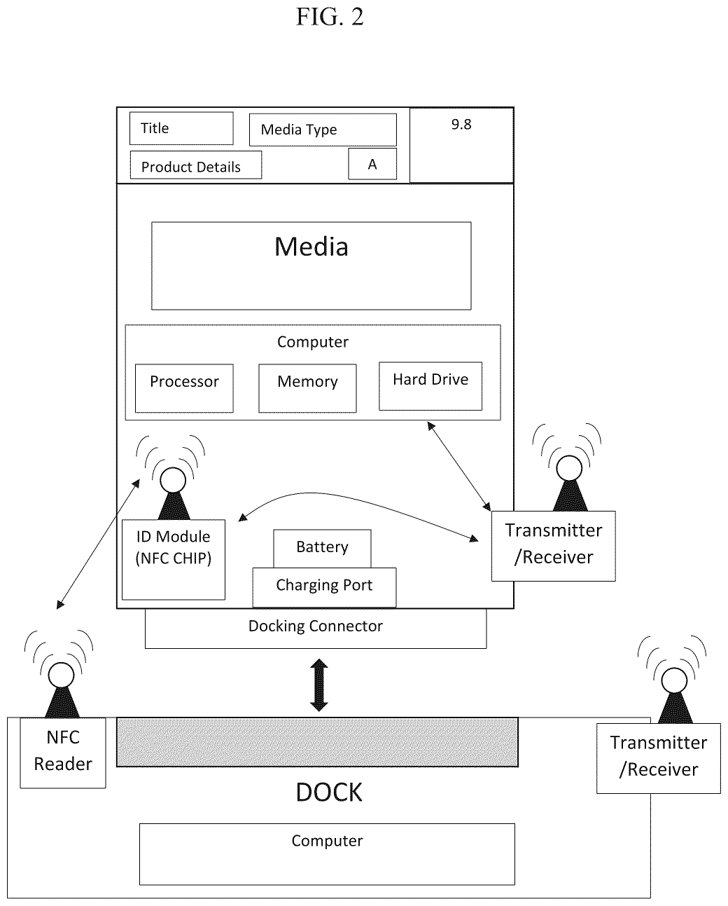

In an example, the storage case may include a docking connector to allow the storage case to physically or wirelessly dock with another device (see, e.g., FIG. 2). Docking the storage case with another device may be employed to allow the owner of the media product stored in the storage case to access the unique content of the media in the storage case without removing the media from the storage case (e.g., the unique content of a stored video game may be made available to the owner by using an emulator, as described herein). The dock to which the storage case is physically or wirelessly connected can also be used to charge the battery of the storage case. As an example, the dock may connect with the storage case through an electro-mechanical connection. The docking connector of the storage case may connect with a receiving port of the dock through a USB-C connection.

An identification module is associated with the storage case (e.g., may be housed within the storage case). The identification module stores a unique identification code used to identify the media product and an owner of the media product, which can be an individual or a juridical entity. While the unique identification code may be communicated by the identification module wirelessly, the unique identification code may also be communicated through a wired connection between the storage case and another device (e.g., a dock, user interface, or media display assembly, as described herein).

In an aspect of the present disclosure, the identification module includes an NFC chip, an RFID tag, a FPGA, or a NFT. As an example, the NFC chip is scannable by a second device with an NFC reader to confirm the unique identification code associated with the media product stored in the storage case. Confirming the unique identification code can be employed to authenticate an individual owner, as an example, of the media product and permitting the individual owner to access the unique content of the media product.

As an example, it can be confirmed that a user is in possession of a graded game without otherwise tracking ownership using the NFC chip embedded in the storage case. NFC chips can be employed to generate a new security code each time the NFC chip is scanned or otherwise accessed that is checked via API calls to an authentication server. Due to this authentication mechanism, the NFC chips are not cloneable.

A transmitter/receiver can be employed to transmit or receive a unique identification code. The transmission of the unique identification code can be used to authenticate ownership of the media product to allow the individual owner to access the unique content of the media product without removing the media product from the storage case.

The ID module can be in communication with the transmitter/receiver to communicate a unique identification code to or from the portable case.

In an aspect of the present disclosure, the media product is a video game, an audiovisual product, an audio recording, a video recording, a written work, or a comic book. Other media products are contemplated, including sports cards, collectable cards, original autographs, original photographs, and other items of values.

In an aspect of the present disclosure, the storage case is configured to communicate with a user interface device through a wired or wireless connection to facilitate the owner consuming the unique content of the at least one media product by using the user interface device. The storage case may include a receiver configured to receive data at the storage case (e.g., from the user interface). The receiver is configured to receive data through a wired or wireless connection. The receiver of the storage case can be employed for identifying what type of device the user interface is embodied in (e.g., a smartphone, tablet computer, or desktop computer) to facilitate the proper communication protocol between the storage case and the user interface. As an example, a smartphone running a user interface may be equipped to interface with the storage case through a WiFi or Bluetooth connection, but not through a physical wired connection. Alternatively, a device running a user interface that is not equipped with wireless communication functionality might only be able to interface with the storage case through a wired connection, such as a USB—C connection.

The storage case may include a port (e.g., a USB-C port) configured to transmit data from the storage case or receive data at the storage case. The port can be employed for communication between a device running a user interface and the storage case.

In an aspect of the present disclosure, the storage case includes a battery, such as a rechargeable battery, that powers the storage case. The port can be employed for charging the rechargeable battery.

Referring particularly to FIG. 2, the storage case can dock with another device including a dock, such as another device including a user interface for displaying the unique content of the media product stored in the storage case. The user interface device facilitates the owner consuming the unique content of the media product. The user interface may be a software application running, such as an application running on a smartphone, tablet compute, or desktop computer. The user interface may also run on a standalone device, such as a specialized hardware device specifically designed for running the user interface.

In an aspect of the present disclosure, the user interface is a separate device from the storage case. The storage case is configured to communicate with a user interface device through a wired or wireless connection to facilitate the owner consuming the unique content of the at least one media product by using the user interface device.

The device including the dock can include a computer and a reading device (e.g., an NFC reader) configured to communicate with the storage case to verify a unique identification code stored, generated, or transmitted by the storage case.

The device including the dock includes a transmitter/receiver for communicating with a remote computer server to transmit or receive data, such as to verify ownership of a media product to allow the media product to be displayed and interacted with. The transmitter/receiver of the dock may also be employed to communicate with the transmitter/receiver of the storage case.

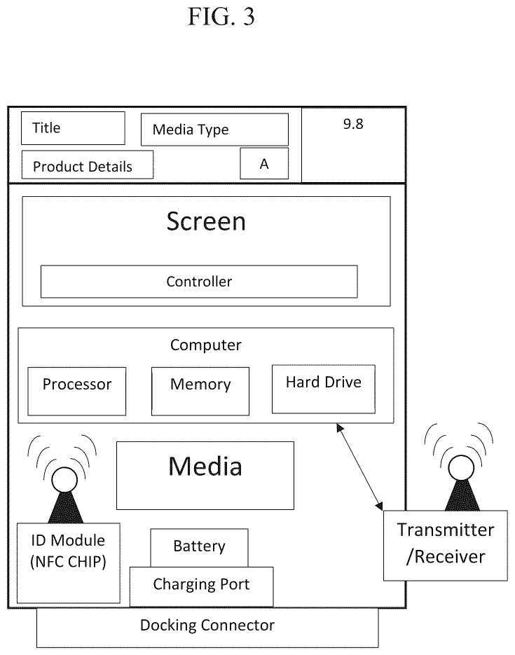

Unless otherwise indicated below, the storage case described below with reference to FIG. 3 is substantially the same as the storage case described above with reference to FIGS. 1-2, and thus duplicative descriptions may be omitted below.

Referring particularly to FIG. 3, a device for authenticating ownership of media includes a user interface in communication with the storage case. The user interface includes a screen and a controller.

In an aspect of the present disclosure, the user interface is embodied in the storage case itself. For example, the storage case may include an integrated screen and controller used to display the unique content of the media product housed therein. That is, the storage case may serve to store a media product, and to allow a user to interact with the content of the media product without actually removing the media product from the storage case.

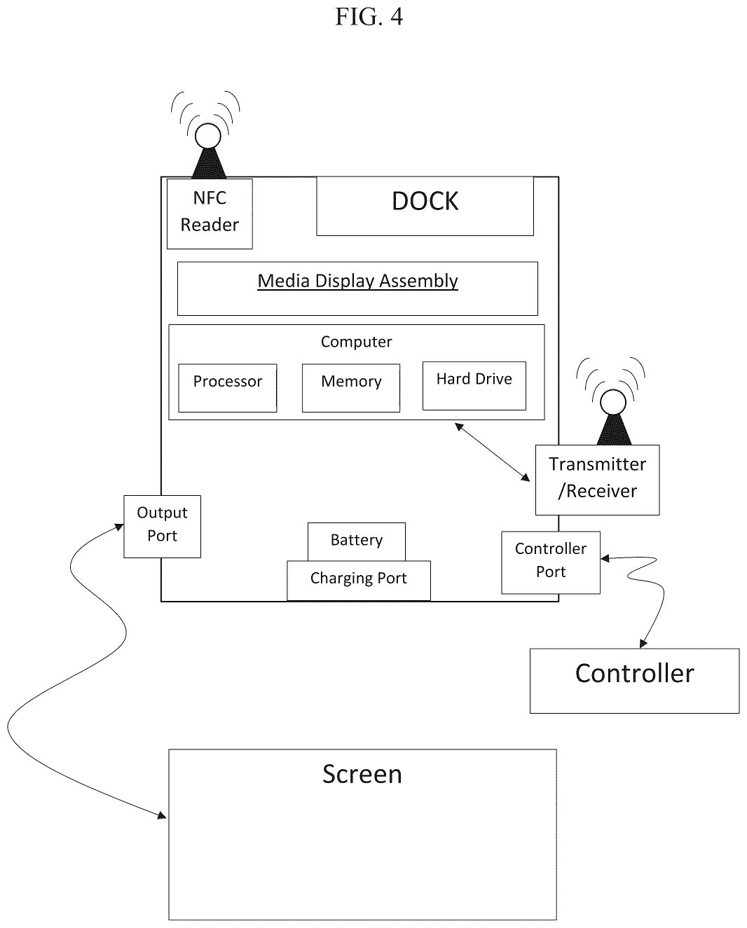

Referring particularly to FIG. 4, a device (e.g., a set-top box) for displaying media stored in the storage case includes a media display assembly including a transmitter/receiver. The receiver is configured to receive a unique identification code from the storage case storing and protecting the media product (or from a server, such as a cloud-based server). The storage case includes a transmitter configured to transmit the unique identification code to the receiver of the media display assembly. Transmission of the unique identification code to the receiver of the media display assembly is used to authenticate ownership of the media product. Authenticating ownership of the media product permits the media display assembly to allow the individual owner to access the unique content of the media product without removing the media product from the storage case.

In an aspect of the present disclosure, a screen is in communication with the media display assembly. The screen is configured to display the unique content of the media product. A controller is in communication with the media display assembly. The controller facilitates the individual owner of the media product interacting with the unique content of the media product displayed on the screen.

The media display assembly may include an NFC reader to scan an NFC chip of the storage case to verify the unique identification code.

The media display assembly may include a computer in communication with the transmitter/receiver and/or in communication with the NFC reader. The media display assembly can include a dock for interfacing (e.g., physically, or wirelessly) with the storage case. The media display assembly may include a battery (e.g., a rechargeable battery) and a charging port. The charging port may also operate as a data transfer port, such as a USB-C type port, that can be employed for updating firmware stored in the media display assembly.

The media display assembly may include an output port for connecting with a screen and/or a controller port for interfacing with a controller.

As an example, the media display assembly can be stylistically formed to resemble a media display console, such as a cable box, a video game console, an audio tape player, a VHS tape player, or a CD/DVD or other disk type player.

In an aspect of the present disclosure, the media display assembly is configured to communicate with the screen or the controller through a wired or wireless connection. The media display assembly may include a controller port configured to provide a wired connection between the controller and the media display assembly. The media display assembly may include a port (e.g., an output port) configured to provide a wired connection between the screen and the media display assembly.

The media display assembly may include a receiver configured to receive data at the media display assembly. The receiver is configured to receive data through a wired or wireless connection.

The media display assembly may include a port (e.g., a USB-C port) configured to transmit data from the media display assembly or receive data at the media display assembly.

In an aspect of the present disclosure, the media display assembly may include a battery, such as a rechargeable battery, for powering the media display assembly. The port of the media display assembly may be a USB-C port configured to recharge the rechargeable battery or to transmit/receive data from or at the media display assembly.

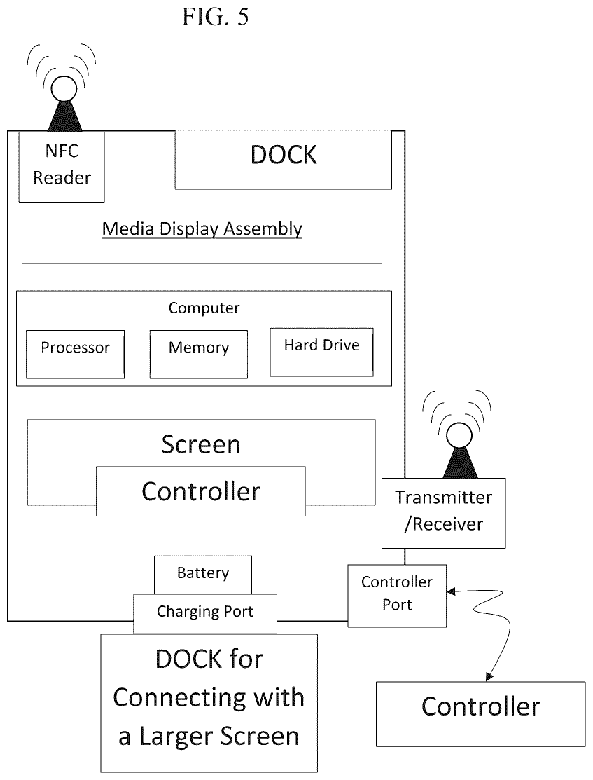

Unless otherwise indicated below, the media display assembly described below with reference to FIG. 5 is substantially the same as the media display assembly described above with reference to FIG. 4, and thus duplicative descriptions may be omitted below.

Referring particularly to FIG. 5, a screen is embodied in a media display assembly, and a controller may be either embodied in, or in communication with the media display assembly.

The media display assembly may be a portable device. As an example, the media display assembly may operate as an autonomous device configured to display and interact with the unique content of a media product stored in a storage case without any other peripheral components.

The media display assembly can also connect (e.g., through a physical or wired connected) to or dock with another device, such as to display the media product on a larger screen from the screen embodied in the media display assembly.

Unless otherwise indicated below, the devices employed in the systems and methods described below may be substantially the same as the devices described above with reference to FIGS. 1-5, and thus duplicative descriptions may be omitted below.

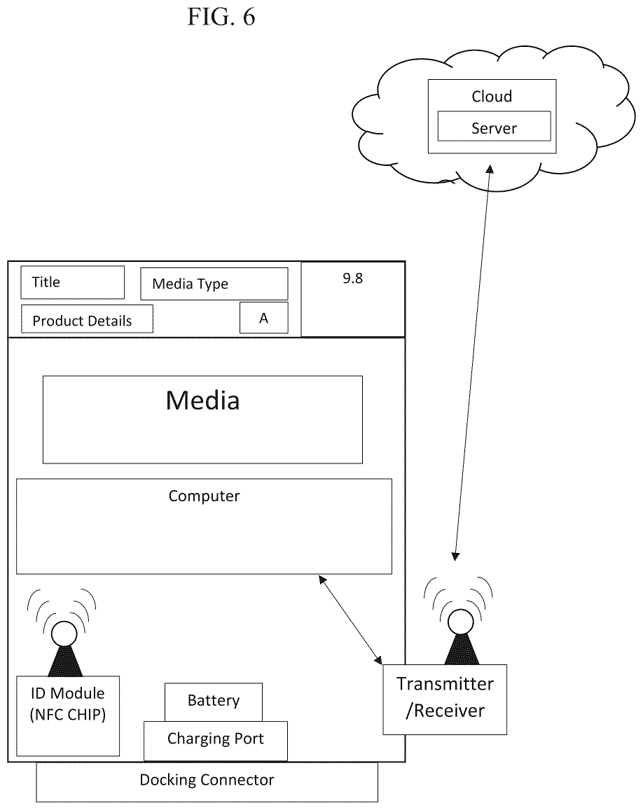

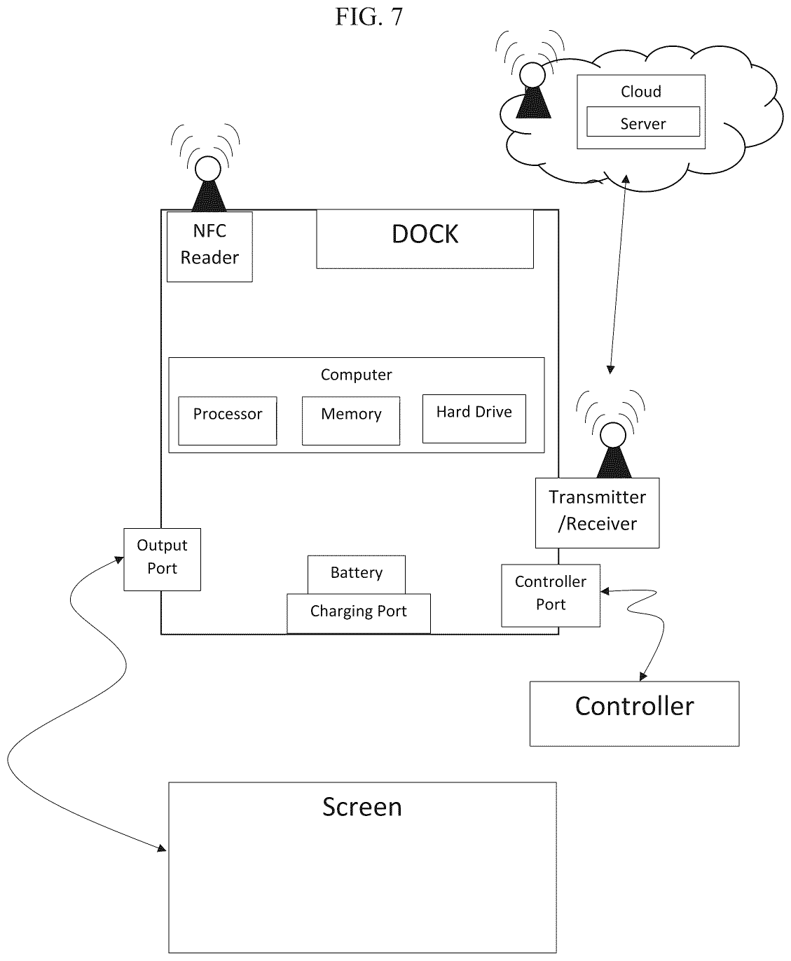

Referring particularly to FIGS. 6-8, a system for authenticating ownership of media includes a transmitter/receiver associated with the storage case. The transmitter/receiver is configured to transmit the unique identification code. A server (e.g., a cloud server) is configured to communicate with the transmitter/receiver to receive the unique identification code to authenticate ownership of the media product to allow the individual owner to access the unique content of the media product without removing the media product from the storage case.

The server may communicate directly with a storage case or with a media display assembly (e.g., a set-top box, a standalone media display device, or a portable media display device).

In an aspect of the present disclosure, the system includes an emulator running on a device connected to the server that is configured to display the unique content of the media product after having received ownership authentication for a particular media product.

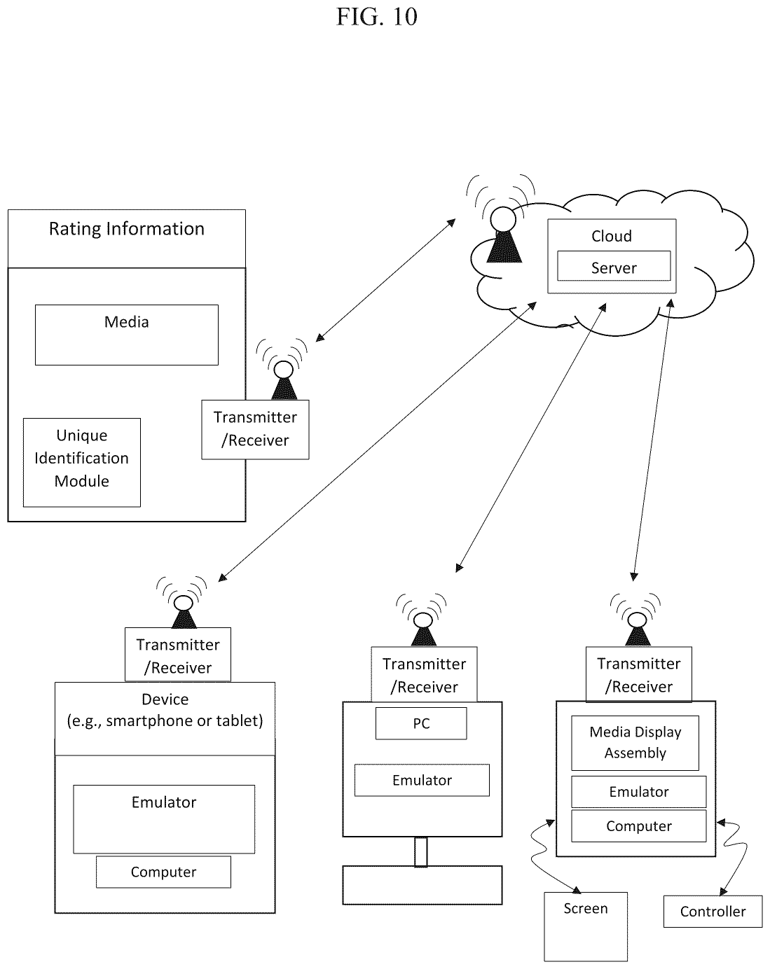

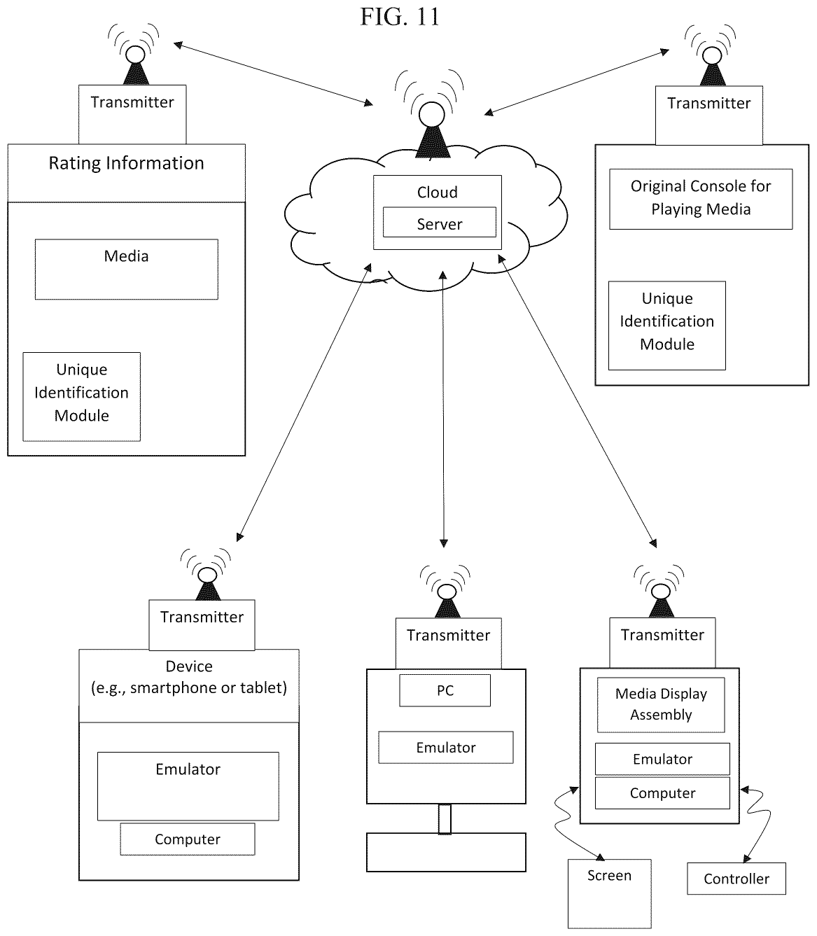

In an aspect of the present disclosure, the emulator is stored on a smartphone, tablet computer, personal computer, or a media display assembly (see, e.g., FIGS. 10-11). Alternatively, the emulator may be accessed through a web browser. The smartphone, tablet computer, personal computer, or media display assembly may run a software application connected with the server. The server may instruct the smartphone application to allow access to the media product. The emulator may be included as a component of the software application.

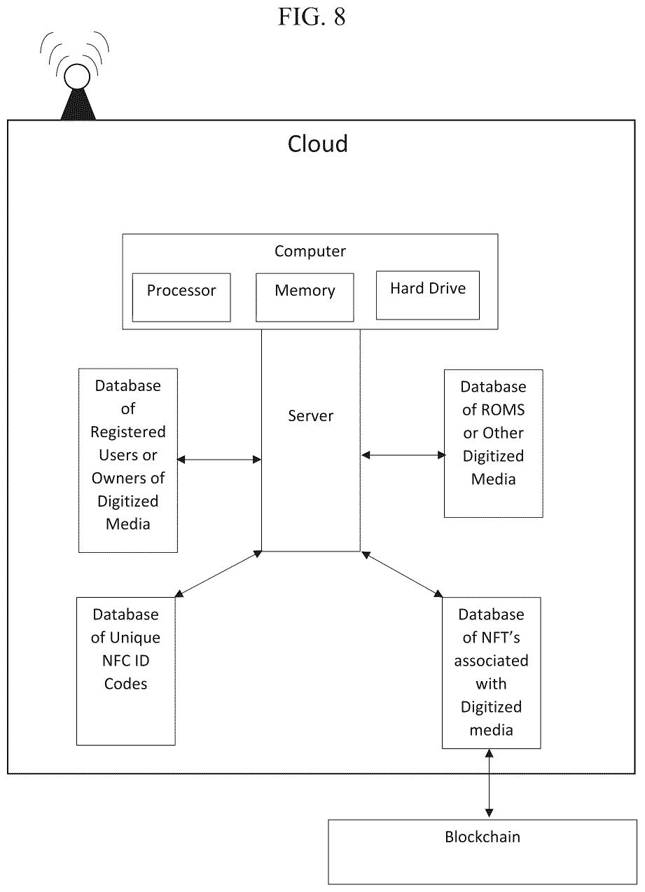

Referring particularly to FIG. 8, the server (e.g., the cloud server) includes a database of registered users (e.g., a vault including a list of registered uses having account credentials, passwords, and corresponding access information for which media products the user should have digital access to), a database of unique ID codes (e.g., NFC codes), a database of available ROMS or other digital media files, and/or a database of NFT's associated with the digitized media products that are authenticated using a blockchain.

A physical vault may act as a depository to hold physically stored media and may serve as a means of verifying ownership of a particular media item. For example, a certificate (e.g., including a unique verification number) identifying the media product and the owner may be generated when a media item is physically stored in the physical vault. The certificate may be employed to allow a user to access a digital form of the media item.

The database of registered users may be employed to allow a media owner using a media display device (e.g., a smartphone, table, PC, or specialized media display device) to gain access to owned media products by using login credentials and without entering a unique identification code. In this instance, the unique identification code associated with a corresponding storage case would be previously stored in the computer server.

The database of ROM or other digitized media files stored in or in communication with the server allows a user to access the digitized media files from any connected device after authenticating ownership of the corresponding media product.

A user interface on the media display device employed by the media product owner can include an emulator configured to display the unique content of the media product using one of the ROM files. As an example, each video game that has been stored in a storage case at least one time in the past may have a corresponding ROM filed stored in the ROM database, and each ROM file can be played using an emulator after authenticating ownership of the corresponding media product.

When a video game, or other media product is stored in a storage case, a unique NFT may be generated by the system which is stored in the NFT database. The unique NFT, authenticated using a blockchain, can be employed by the server/media display device to confirm ownership of the particular media product, and thus to allow the owner of the particular media product to access and use the corresponding digitized media file (e.g., to run a ROM of a video game on an emulator).

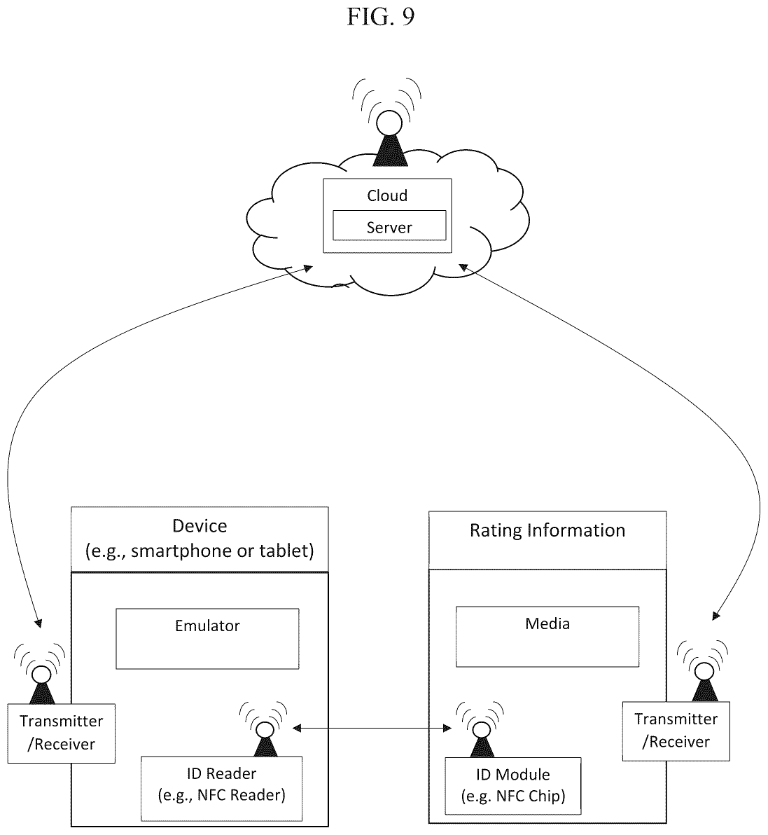

Referring particularly to FIG. 9, a system for authenticating ownership of a media product and displaying the media product includes an identification module (e.g., an NFC chip) associated with the storage case. The identification module stores a unique identification code used to identify the media product (e.g., a video game) and an individual owner of the media product. A device (e.g., a smartphone or table computer) configured to display the unique content of the media product includes an identification code reader (e.g., an NFC reader). The identification code reader is configured to read the unique identification code to authenticate ownership of the media product to allow the device to display the unique content of the media product without removing the media product from the storage case.

As an example, an NFC reader of a smartphone or tablet can “tap” near an NFC chip of a storage case to verify ownership of a media product stored in the storage case. The smartphone or tablet running a software application having an emulator can then receive a signal authenticating ownership of the media product and launch the emulator to display and interact with the media product. As an example, a ROM file for a video game may be run from a server or can be downloaded and saved on a hard drive of the media display device (e.g., smartphone, tablet, PC, or other specialized hardware device). Alternatively, a ROM may be stored on a solid state storage device in a storage case and the ROM may be pulled from the solid state storage device to an emulation device (e.g., by using a cable, such as a USB or other transfer cable, or by wireless transmitting the ROM).

Referring particularly to FIG. 10, a system for authenticating and displaying a digital media product can employ a media display device (e.g., smartphone, tablet, PC, or a specialized media display assembly) for displaying/interacting with the media product after ownership of the media product is authenticated. The media display device may be in communication with a remote server (e.g., a cloud server) and may receive authentication of ownership of the media product therefrom.

The digitized media files (e.g., ROMS) may be stored on a hard drive of a corresponding media display device (e.g., smartphone, tablet, PC, or specialized hardware device).

According to an aspect of the present disclosure, when a digitized media file is stored on a local hard drive of a media display device, the system may require re-verification of ownership of the media product at predetermined time points (e.g., every time that the media product is displayed, one time monthly, or annually), or after a predetermined number of uses of the media product.

Referring particularly to FIG. 11, a system for authenticating ownership of media and displaying the media includes a first storage case configured to store and protect a media product including unique content. A first identification module associated with the first storage case stores a first unique identification code used to identify the media product and an owner of the media product, which can be an individual or a juridical entity. A first transmitter associated with the first storage case transmits the first unique identification code. A server in communication with the first transmitter receives the first unique identification code. A second storage case is configured to store and protect a media console. The media console is configured to interface with the media product to display the unique content of the media product. A second identification module associated with the second storage case stores a second unique identification code used to identify the media console and an individual owner, as an example, of the media product. The individual owner of the media product is the same owner as the individual owner of the media console. A second transmitter associated with the second storage case transmits the second unique identification code to the server. Transmission of the first unique identification code and the second unique identification code to the server is used to authenticate ownership of the media product and to authenticate ownership of the media console to allow the individual owner to access the unique content of the media product without removing the media product from the first storage case and without removing the media console from the second storage case.

In an aspect of the present disclosure, the first identification module includes an NFC chip, an RFID tag, a FPGA, or a NFT, and the second identification module includes an NFC chip, an RFID tag, a FPGA, or a NFT.

The console for playing media (e.g., a video game console) may be encapsulated and stored in a storage case similarly to a media product (e.g., a video game). Therefore, ownership of each of the media product and the console may be authenticated and a media display device may then be authorized to display and interact with the media product.

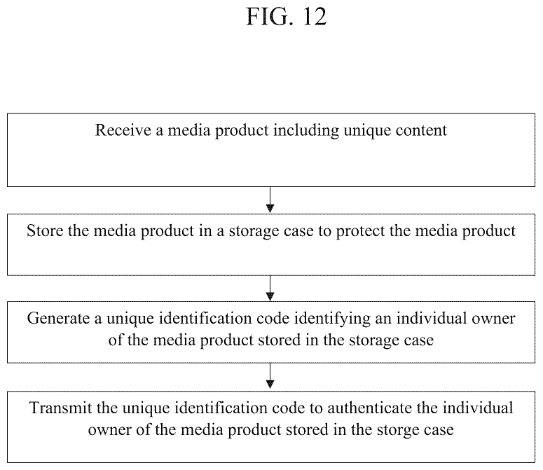

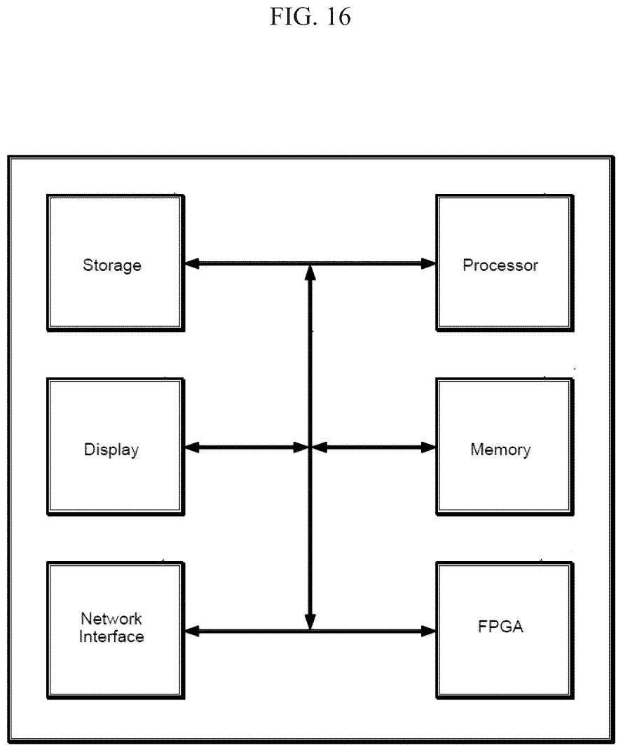

The methods described below with reference to FIGS. 12-15 may be computer-implemented methods performed by a computer, such as the computer described in more detail below with reference to FIG. 16. The computer stores computer instructions (e.g., instructions stored in a hard drive thereof), that are executable by the processor to perform the corresponding algorithm(s).

Referring to FIG. 12, a method of authenticating ownership of media includes receiving a media product and storing the media product in a storage case to protect the media product. A unique identification code identifying an individual owner of the media product stored in the storage case is generated. The unique identification code is transmitted to authenticate the individual owner of the media product stored in the storage case.

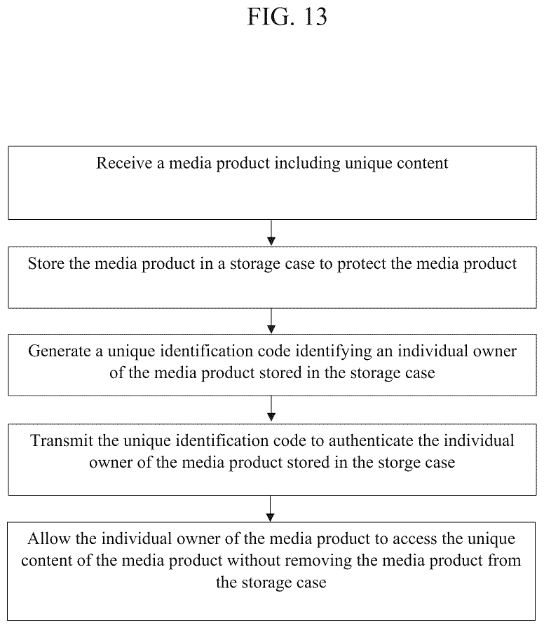

Referring particularly to FIG. 13, the method includes allowing the individual owner of the media product to access the unique content of the media product without removing the media product from the storage case. The media product may be accessed using a media display device (e.g., a smartphone, tablet, PC, or specialized media display device) that receives an authentication signal confirming ownership of a particular media product. The received signal may be a local signal over a short physical distance (e.g., 1-10 inches for an NFC chip), or the signal may be received from a server (e.g., a cloud server).

In an aspect of the present disclosure, the method includes grading the media product to generate a quality rating for the media product and displaying the quality rating on the storage case. The grading may be performed before storing the media product in the storage case.

In an aspect of the present disclosure, generating the unique identification code includes generating a NFT authenticated using a blockchain.

In an aspect of the present disclosure, the storage case holding the media product may be transferred to a storage vault. The owner of the media product may be allowed to access the unique content of media product without removing the storage case storing the media product from the storage vault.

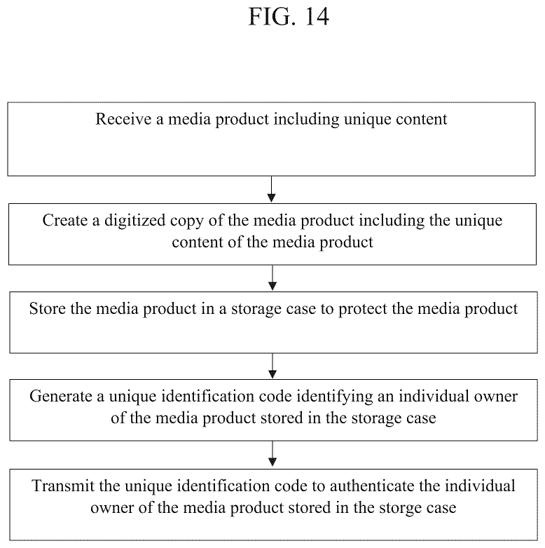

Referring particularly to FIG. 14, a method of authenticating ownership of media includes creating a digitized copy of the media product including the unique content of the media product before storing the media product in a storage case. Digitizing the media product allows the media product to be stored without any physical degradation that may occur with a physical product, such as a disk, storing the media product. The processing of digitizing the media product may be employed for each owner of a media product to create an individual copy associated with each user. A digital file storing the unique content of the media product may be generated to include a unique code for identifying the owner of a particular digitized copy of a media product. The unique code may be employed to confirm that a particular digital file is being accessed (e.g., through a server, such as a cloud server, streaming the contents of the digital file to an emulator) by the correct corresponding owner. Each digital media file can be used to generate a NFT that is authenticated using a blockchain, as described herein.

Alternatively, a single digital file may be generated for a corresponding media product and accessible by all verified owners of the corresponding media product. As an example, and in use, when a particular video game is first encapsulated in a storage case, a digital file (e.g., a ROM) of the video game may be generated and stored in a database (e.g., in a server, such as a cloud-based server). When a second copy of the same video game is encapsulated in another storage case at another time, a digitized copy might not be made because a digital copy of the video game is already stored in the database. This process can reduce an amount of data stored in a database, while still allowing any verified owner to access the content of the video game.

Accessing a single digital file for a media product by multiple owners of the media product allows a previously opened media product to be used for generating the initial digital file, while avoiding the need for opening an unopened copy of the same media product to create a digitized copy. For example, an owner of a first video game that has been previously removed from its original packaging may agree to have the first video game used to create a digital copy of the video game, and when a second owner presenting a second copy of the same unique video game in its original unopened packaging as the digital copy encapsulates that second video game in a storage case there is no need to remove the second unopened game from its original packaging to create a digital copy of the second video game.

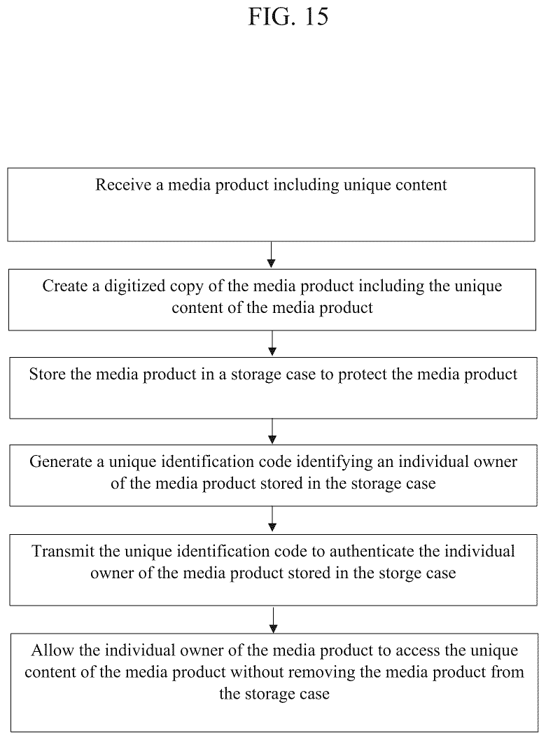

Referring particularly to FIG. 15, the method includes allowing the owner of the media product to display and interact with the particular digitized copy of the media product after authenticating ownership of the media product. The media product may be accessed using a media display device (e.g., a smartphone, tablet, PC, or specialized media display device) that receives an authentication signal confirming ownership of a particular media product. The received signal may be a local signal over a short physical distance (e.g., 1-10 inches for an NFC chip), or the signal may be received from a server (e.g., a cloud server).

Displaying and interacting with a digitized copy of a media product may be achieved by downloading and locally storing a copy of the digitized media product for access by local software or a local application, such as an emulator running on a local device. Alternatively, the digitized copy of the media product may be accessible by streaming the unique content of the media product through a web browser.

Referring to FIG. 16, a general-purpose computer is described. The general-purpose computer can be employed by the devices, systems and methods described herein to perform the various methods and algorithms described herein. The computer may include a processor connected to a computer-readable storage medium or a memory which may be a volatile type memory, e.g., RAM, or a non-volatile type memory, e.g., flash media, disk media, etc. The processor may be another type of processor such as, without limitation, a digital signal processor, a microprocessor, an ASIC, a graphics processing unit (GPU), field-programmable gate array (FPGA), or a central processing unit (CPU).

In some aspects of the disclosure, the memory can be random access memory, read-only memory, magnetic disk memory, solid state memory, optical disc memory, and/or another type of memory. The memory can communicate with the processor through communication buses of a circuit board and/or through communication cables such as serial ATA cables or other types of cables. The memory includes computer-readable instructions that are executable by the processor to operate the computer to execute the algorithms described herein. The computer may include a network interface to communicate (e.g., through a wired or wireless connection) with other computers or a server. A storage device may be used for storing data. The computer may include one or more FPGAs. The FPGAs may be used for executing various machine learning algorithms. The FPGAs may also be configured to perform hardware emulation (e.g., of an original video game console hardware). A display may be employed to display data processed by the computer.

The computer of the storage case may be configured to enter a read/write mode to write data to the NFC tag to program the NFC tag. Thus, the unique identification code for the NFC tag can be generated and/or changed by the storage case itself. As an example, the unique code of the NFC tag may be changed at predetermined time points, such as after each session of accessing the unique content of the media stored in the storage case. Each unique code can be uploaded to the server (e.g., the cloud server) and then downloaded by any of the devices (e.g., smartphone/tablet, PC, or the media display assembly). Alternatively, a separate device, such as a smartphone, tablet, or PC could be employed for programming or reprogramming the NFC tag. Allowing the NFC tag to be programmable in the field allows a generic case to be manufactured and customized in the field, rather than programming each storage case individually during manufacturing, thus increasing the efficiency of production and practicality of use of the storage case.

In an aspect of the present disclosure, an ID tag (e.g., an NFC tag) can be applied to a loose media product that is not stored in a storage case. As an example, this may be employed for a video game that is not graded. The ID tag can allow use of the media product when the media product is not physically present.

In an aspect of the present disclosure, the owner of a particular media product could virtually loan or rent access to a particular media product. For example, unique identification code may be configured to loan or rent to a single second person for a predetermined amount of time. The server may facilitate access for a second person to display and/or interact with the media product for a limited period of time by verifying that the owner of the media product has authorized the access. The owner of the media product might not have access to the media product while it is rented or loaned to the second person. The second person can access the media product via an analogous media display device (e.g., smartphone, tablet, PC, or specialized media display device).

According to an aspect of the present disclosure, the NFC tag or the NFT could included some portion of the serial number of the media stored in the storage case.

Methods of use and of making the devices and systems of the present inventive concept are also within the scope of the present inventive concept.

It will be understood that various modifications may be made to the aspects and features disclosed herein. Therefore, the above description should not be construed as limiting, but merely as exemplifications of various aspects and features. Those skilled in the art will envision other modifications within the scope and spirit of the claims appended thereto.

### Example Embodiments

The following are numbered example embodiments of the devices, systems, and methods related to authenticating ownership of media and displaying of same. Examples 1-90 or any other examples disclosed herein may be combined in whole or in part. Elements of the examples disclosed herein are not limiting.

Example 1: A device for authenticating ownership of media, comprising: a storage case configured to store and protect at least one media product, the at least one media product including unique content; an identification module associated with the storage case, wherein the identification module stores a unique identification code used to identify the at least one media product and an owner of the at least one media product; and a transmitter configured to transmit the unique identification code, wherein transmission of the unique identification code is used to authenticate ownership of the at least one media product to allow the owner to access the unique content of the at least one media product without removing the at least one media product from the storage case.

Example 2: The device for authenticating ownership of media, system, or method of any of Examples 1-90 or any other embodiment described herein, wherein the storage case includes a rating banner indicative of a quality rating for the at least one media product.

Example 3: The device for authenticating ownership of media, system, or method of any of Examples 1-90 or any other embodiment described herein, wherein the identification module includes at least one of an NFC chip, an RFID tag, a FPGA, and a NFT.

Example 4: The device for authenticating ownership of media, system, or method of any of Examples 1-90 or any other embodiment described herein, wherein the at least one media product is a video game, an audiovisual product, an audio recording, a video recording, a written work, or a comic book.

Example 5: The device for authenticating ownership of media, system, or method of any of Examples 1-90 or any other embodiment described herein, wherein the storage case is configured to dock with a user interface device, and wherein the user interface device is configured to facilitate the owner consuming the unique content of the at least one media product.

Example 6: The device for authenticating ownership of media, system, or method of any of Examples 1-90 or any other embodiment described herein, wherein the storage case is configured to communicate with a user interface device through a wired or wireless connection to facilitate the owner consuming the unique content of the at least one media product by using the user interface device.

Example 7: The device for authenticating ownership of media, system, or method of any of Examples 1-90 or any other embodiment described herein, further including a receiver configured to receive data at the storage case, wherein the receiver is configured to receive data through a wired or wireless connection.

Example 8: The device for authenticating ownership of media, system, or method of any of Examples 1-90 or any other embodiment described herein, further including a port configured to transmit data from the storage case or receive data at the storage case.

Example 9: The device for authenticating ownership of media, system, or method of any of Examples 1-90 or any other embodiment described herein, further including a battery arranged about the storage case, wherein the battery is configured to power the storage case.

Example 10: The device for authenticating ownership of media, system, or method of any of Examples 1-90 or any other embodiment described herein, wherein the battery is a rechargeable battery, and wherein the port is a USB-C port configured to recharge the rechargeable battery.

Example 11: A device for authenticating ownership of media, comprising: a storage case configured to store and protect at least one media product, the at least one media product including unique content; an identification module associated with the storage case, wherein the identification module stores a unique identification code used to identify the at least one media product and an owner of the at least one media product; a transmitter configured to transmit the unique identification code, wherein transmission of the unique identification code is used to authenticate ownership of the at least one media product to allow the owner to access the unique content of the at least one media product without removing the at least one media product from the storage case; and a user interface in communication with the storage case, the user interface including at least a screen and a controller, wherein the user interface is configured to facilitate the owner consuming the unique content of the at least one media product.

Example 12: The device for authenticating ownership of media, system, or method of any of Examples 1-90 or any other embodiment described herein, wherein the storage case includes a rating banner indicative of a quality rating for the at least one media product.

Example 13: The device for authenticating ownership of media, system, or method of any of Examples 1-90 or any other embodiment described herein, wherein the identification module includes at least one of an NFC chip, an RFID tag, a FPGA, and a NFT.

Example 14: The device for authenticating ownership of media, system, or method of any of Examples 1-90 or any other embodiment described herein, wherein the at least one media product is a video game, an audiovisual product, an audio recording, a video recording, a written work, or a comic book.

Example 15: The device for authenticating ownership of media, system, or method of any of Examples 1-90 or any other embodiment described herein, wherein the user interface is embodied in the storage case.

Example 16: The device for authenticating ownership of media, system, or method of any of Examples 1-90 or any other embodiment described herein, wherein the user interface is a separate device from the storage case, and wherein the storage case is configured to communicate with a user interface device through a wired or wireless connection to facilitate the owner consuming the unique content of the at least one media product by using the user interface device.

Example 17: The device for authenticating ownership of media, system, or method of any of Examples 1-90 or any other embodiment described herein, further including a receiver configured to receive data at the storage case, wherein the receiver is configured to receive data through a wired or wireless connection.

Example 18: The device for authenticating ownership of media, system, or method of any of Examples 1-90 or any other embodiment described herein, further including a port configured to transmit data from the storage case or receive data at the storage case.

Example 19: The device for authenticating ownership of media, system, or method of any of Examples 1-90 or any other embodiment described herein, further including a battery arranged about the storage case, wherein the battery is configured to power the storage case.

Example 20: The device for authenticating ownership of media, system, or method of any of Examples 1-90 or any other embodiment described herein, wherein the battery is a rechargeable battery, and wherein the port is a USB-C port configured to recharge the rechargeable battery.

Example 21: A device for displaying media, comprising: a media display assembly including a receiver, wherein the receiver is configured to receive a unique identification code from a storage case storing and protecting at least one media product, the at least one media product including unique content, the storage case including: an identification module, wherein the identification module stores the unique identification code used to identify the at least one media product and an owner of the at least one media product; and a transmitter configured to transmit the unique identification code to the receiver, wherein transmission of the unique identification code to the receiver of the media display assembly is used to authenticate ownership of the at least one media product, and wherein authenticating ownership of the at least one media product permits the media display assembly to allow the owner to access the unique content of the at least one media product without removing the at least one media product from the storage case.

Example 22: The device for displaying media, system, or method of any of Examples 1-90 or any other embodiment described herein, further including: a screen in communication with the media display assembly, the screen configured to display the unique content of the at least one media product; and a controller in communication with the media display assembly, the controller configured to facilitate the owner of the at least one media product interacting with the unique content of the at least one media product displayed on the screen.

Example 23: The device for displaying media, system, or method of any of Examples 1-90 or any other embodiment described herein, wherein the media display assembly is configured to communicate with the screen or the controller through a wired or wireless connection.

Example 24: The device for displaying media, system, or method of any of Examples 1-90 or any other embodiment described herein, wherein the media display assembly includes at least one of a controller port configured to provide a wired connection between the controller and the media display assembly, or an output port configured to provide a wired connection between the screen and the media display assembly.

Example 25: The device for displaying media, system, or method of any of Examples 1-90 or any other embodiment described herein, further including: a screen embodied in the media display assembly, the screen configured to display the unique content of the at least one media product; and a controller in communication with the media display assembly, the controller configured to facilitate the owner of the at least one media product interacting with the unique content of the at least one media product displayed on the screen, wherein the media display assembly is portable.

Example 26: The device for displaying media, system, or method of any of Examples 1-90 or any other embodiment described herein, wherein the portable media display assembly is configured to connect with another device configured to display the unique content of the at least one media product.

Example 27: The device for displaying media, system, or method of any of Examples 1-90 or any other embodiment described herein, further including a receiver configured to receive data at the media display assembly, wherein the receiver is configured to receive data through a wired or wireless connection.

Example 28: The device for displaying media, system, or method of any of Examples 1-90 or any other embodiment described herein, further including a port configured to transmit data from the media display assembly or receive data at the media display assembly.

Example 29: The device for displaying media, system, or method of any of Examples 1-90 or any other embodiment described herein, further including a battery arranged about the media display assembly, wherein the battery is configured to power the media display assembly.

Example 30: The device for displaying media, system, or method of any of Examples 1-90 or any other embodiment described herein, wherein the battery is a rechargeable battery, and wherein the port is a USB-C port configured to recharge the rechargeable battery.

Example 31: A system for authenticating ownership of media, comprising: a storage case configured to store and protect at least one media product, the at least one media product including unique content; an identification module associated with the storage case, wherein the identification module stores a unique identification code used to identify the at least one media product and an owner of the at least one media product; a transmitter associated with the storage case, the transmitter configured to transmit the unique identification code; and a server configured to communicate with the transmitter to receive the unique identification code, wherein transmission of the unique identification code to the server is used to authenticate ownership of the at least one media product to allow the owner to access the unique content of the at least one media product without removing the at least one media product from the storage case.

Example 32: The system for authenticating ownership of media, device, or method of any of Examples 1-90 or any other embodiment described herein, wherein the storage case includes a rating banner indicative of a quality rating for the at least one media product.

Example 33: The system for authenticating ownership of media, device, or method of any of Examples 1-90 or any other embodiment described herein, wherein the identification module includes an NFC chip, an RFID tag, a FPGA, or a NFT.

Example 34: The system for authenticating ownership of media, device, or method of any of Examples 1-90 or any other embodiment described herein, wherein the at least one media product is a video game, an audiovisual product, an audio recording, a video recording, a written work, or a comic book.

Example 35: The system for authenticating ownership of media, device, or method of any of Examples 1-90 or any other embodiment described herein, wherein the storage case is configured to dock with a user interface device, and wherein the user interface device is configured to facilitate the owner consuming the unique content of the at least one media product.

Example 36: The system for authenticating ownership of media, device, or method of any of Examples 1-90 or any other embodiment described herein, wherein the server is a cloud server.

Example 37: The system for authenticating ownership of media, device, or method of any of Examples 1-90 or any other embodiment described herein, further including an emulator configured to display the unique content of the at least one media product.

Example 38: The system for authenticating ownership of media, device, or method of any of Examples 1-90 or any other embodiment described herein, wherein the emulator is stored on a smartphone, tablet computer, personal computer, or a media display assembly.

Example 39: The system for authenticating ownership of media, device, or method of any of Examples 1-90 or any other embodiment described herein, further including: a database of ROM files in communication with the server; and a user interface including an emulator, the emulator configured to display the unique content of the at least one media product using a ROM file of the ROM files.

Example 40: The system for authenticating ownership of media, device, or method of any of Examples 1-90 or any other embodiment described herein, wherein the storage case is configured to communicate with a user interface device through a wired or wireless connection to facilitate the owner consuming the unique content of the at least one media product by using the user interface device.

Example 41: The system for authenticating ownership of media, device, or method of any of Examples 1-90 or any other embodiment described herein, further including a receiver configured to receive data at the storage case, wherein the receiver is configured to receive data through a wired or wireless connection.

Example 42: The system for authenticating ownership of media, device, or method of any of Examples 1-90 or any other embodiment described herein, further including a port configured to transmit data from the storage case or receive data at the storage case.

Example 43: The system for authenticating ownership of media, device, or method of any of Examples 1-90 or any other embodiment described herein, further including a battery arranged about the storage case, wherein the battery is configured to power the storage case.

Example 44: The system for authenticating ownership of media, device, or method of any of Examples 1-90 or any other embodiment described herein, wherein the battery is a rechargeable battery, and wherein the port is a USB-C port configured to recharge the rechargeable battery.

Example 45: A system for displaying media, comprising: a storage case configured to store and protect at least one media product, the at least one media product including unique content; an identification module associated with the storage case, wherein the identification module stores a unique identification code used to identify the at least one media product and an owner of the at least one media product; a device configured to display the unique content of the at least one media product; and an identification code reader associated with the device, wherein the identification code reader is configured to read the unique identification code to authenticate ownership of the at least one media product to allow the device to display the unique content of the at least one media product without removing the at least one media product from the storage case.

Example 46: The system for displaying media, device, or method of any of Examples 1-90 or any other embodiment described herein, wherein the identification module includes an NFC chip, and wherein the ID reader includes an NFC reader.

Example 47: The system for displaying media, device, or method of any of Examples 1-90 or any other embodiment described herein, wherein the device includes an emulator configured to display the unique content of the at least one media product.

Example 48: The system for displaying media, device, or method of any of Examples 1-90 or any other embodiment described herein, wherein the emulator is stored on a smartphone, tablet computer, personal computer, or a specialized hardware module.

Example 49: The system for displaying media, device, or method of any of Examples 1-90 or any other embodiment described herein, wherein the storage case includes a transmitter and receiver configured to communicate with a server to transfer data between the storage case and the server through a wired or wireless connection.

Example 50: The system for displaying media, device, or method of any of Examples 1-90 or any other embodiment described herein, wherein the device includes a transmitter and receiver configured to communicate with a server to transfer data between the storage case and the server through a wired or wireless connection.

Example 51: The system for displaying media, device, or method of any of Examples 1-90 or any other embodiment described herein, further including a screen and a controller in communication with the device to allow the user to interact with the unique content of the at least one media product.

Example 52: A system for authenticating ownership of media, comprising: a first storage case configured to store and protect at least one media product, the at least one media product including unique content; a first identification module associated with the first storage case, wherein the first identification module stores a first unique identification code used to identify the at least one media product and an owner of the at least one media product; a first transmitter associated with the first storage case, the first transmitter configured to transmit the first unique identification code; a server configured to communicate with the first transmitter to receive the first unique identification code, a second storage case configured to store and protect at least one media console, the at least one media console configured to interface with the at least one media product to display the unique content of the at least one media product; a second identification module associated with the second storage case, wherein the second identification module stores a second unique identification code used to identify the at least one media console and an owner of the at least one media product, wherein the owner of the at least one media product is the same owner as the owner of the at least one media console; and a second transmitter associated with the second storage case, the second transmitter configured to transmit the second unique identification code; wherein the server is configured to communicate with the second transmitter to receive the second unique identification code, wherein transmission of the first unique identification code and the second unique identification code to the server is used to authenticate ownership of the at least one media product and to authenticate ownership of the at least one media console to allow the owner to access the unique content of the at least one media product without removing the at least one media product from the first storage case and without removing the at least one media console from the second storage case.

Example 53: The system for authenticating ownership of media, device, or method of any of Examples 1-90 or any other embodiment described herein, wherein the first identification module includes an NFC chip, an RFID tag, a FPGA, or a NFT, and the second identification module includes an NFC chip, an RFID tag, a FPGA, or a NFT.

Example 54: The system for authenticating ownership of media, device, or method of any of Examples 1-90 or any other embodiment described herein, wherein the at least one media product is a video game, an audiovisual product, an audio recording, a video recording, a written work, or a comic book.

Example 55: The system for authenticating ownership of media, device, or method of any of Examples 1-90 or any other embodiment described herein, wherein the server is a cloud server.

Example 56: The system for authenticating ownership of media, device, or method of any of Examples 1-90 or any other embodiment described herein, further including an emulator configured to display the unique content of the at least one media product.

Example 57: The system for authenticating ownership of media, device, or method of any of Examples 1-90 or any other embodiment described herein, wherein the emulator is stored on a smartphone, tablet computer, personal computer, or a specialized hardware module.

Example 58: The system for authenticating ownership of media, device, or method of any of Examples 1-90 or any other embodiment described herein, further including: a database of ROM files in communication with the server; and a user interface including an emulator, the emulator configured to display the unique content of the at least one media product using a ROM file of the ROM files.

Example 59: The system for authenticating ownership of media, device, or method of any of Examples 1-90 or any other embodiment described herein, further including a user interface device configured to communicate with the server to facilitate the owner consuming the unique content of the at least one media product by using the user interface device.

Example 60: The system for authenticating ownership of media, device, or method of any of Examples 1-90 or any other embodiment described herein, wherein the user interface device is in communication with at least one of a controller or a screen to allow the user to interact with the at least one media product.

Example 61: A method of authenticating ownership of media, comprising: receiving at least one media product, the at least one media product including unique content; storing the at least one media product in a storage case to protect the at least one media product; generating a unique identification code identifying an owner of the at least one media product stored in the storage case; and transmitting the unique identification code to authenticate the owner of the at least one media product stored in the storage case.

Example 62: The method of authenticating ownership of media, system, or device of any of Examples 1-90 or any other embodiment described herein, further including: allowing the owner of the at least one media product to access the unique content of the at least one media product without removing the at least one media product from the storage case.

Example 63: The method of authenticating ownership of media, system, or device of any of Examples 1-90 or any other embodiment described herein, further including grading the media product to generate a quality rating for the at least one media product.

Example 64: The method of authenticating ownership of media, system, or device of any of Examples 1-90 or any other embodiment described herein, further including displaying the quality rating on the storage case.

Example 65: The method of authenticating ownership of media, system, or device of any of Examples 1-90 or any other embodiment described herein, wherein the transmitted unique identification code includes data from an NFC chip, an RFID tag, a FPGA, or a NFT.

Example 66: The method of authenticating ownership of media, system, or device of any of Examples 1-90 or any other embodiment described herein, wherein the at least one media product is a video game, an audiovisual product, an audio recording, a video recording, a written work, or a comic book.

Example 67: The method of authenticating ownership of media, system, or device of any of Examples 1-90 or any other embodiment described herein, further including docking the storage case with a user interface device, wherein the user interface device is configured to facilitate the owner consuming the unique content of the at least one media product.

Example 68: The method of authenticating ownership of media, system, or device of any of Examples 1-90 or any other embodiment described herein, wherein the at least one media product is a video game.

Example 69: The method of authenticating ownership of media, system, or device of any of Examples 1-90 or any other embodiment described herein, further including: receiving a ROM file including a digital copy of the video game; and playing the ROM file using an emulator.

Example 70: The method of authenticating ownership of media, system, or device of any of Examples 1-90 or any other embodiment described herein, wherein the emulator is stored on a smartphone, tablet computer, personal computer, or a specialized hardware module.

Example 71: The method of authenticating ownership of media, system, or device of any of Examples 1-90 or any other embodiment described herein, wherein the emulator is accessed through a web browser.

Example 72: The method of authenticating ownership of media, system, or device of any of Examples 1-90 or any other embodiment described herein, wherein generating the unique identification code includes generating a NFT authenticated using a blockchain.

Example 73: The method of authenticating ownership of media, system, or device of any of Examples 1-90 or any other embodiment described herein, further including transmitting the unique identification code to a user interface device through a wired or wireless connection to facilitate the owner consuming the unique content of the at least one media product by using the user interface device.

Example 74: The method of authenticating ownership of media, system, or device of any of Examples 1-90 or any other embodiment described herein, further including storing the unique identification code in a server, and transmitting the unique identification code from the server to the user interface.

Example 75: The method of authenticating ownership of media, system, or device of any of Examples 1-90 or any other embodiment described herein, further including transferring the storage case to a storage vault, and allowing the owner of the at least one media product to access the unique content of the at least one media product without removing the at least one media product from the storage vault.

Example 76: A method of authenticating ownership of media, comprising: receiving at least one media product, the at least one media product including unique content; creating a digitized copy of the at least one media product including the unique content of the at least one media product; storing the at least one media product in a storage case to protect the at least one media product; generating a unique identification code identifying an owner of the at least one media product stored in the storage case; and transmitting the unique identification code to authenticate the owner of the at least one media product stored in the storage case.

Example 77: The method of authenticating ownership of media, system, or device of any of Examples 1-90 or any other embodiment described herein, further including: allowing the owner of the at least one media product to access the digitized copy of the at least one media product without removing the at least one media product from the storage case.

Example 78: The method of authenticating ownership of media, system, or device of any of Examples 1-90 or any other embodiment described herein, further including grading the media product to generate a quality rating for the at least one media product.

Example 79: The method of authenticating ownership of media, system, or device of any of Examples 1-90 or any other embodiment described herein, further including displaying the quality rating on the storage case.

Example 80: The method of authenticating ownership of media, system, or device of any of Examples 1-90 or any other embodiment described herein, wherein the transmitted unique identification code includes data from an NFC chip, an RFID tag, a FPGA, or a NFT.

Example 81: The method of authenticating ownership of media, system, or device of any of Examples 1-90 or any other embodiment described herein, wherein the at least one media product is a video game, an audiovisual product, an audio recording, a video recording, a written work, or a comic book.

Example 82: The method of authenticating ownership of media, system, or device of any of Examples 1-90 or any other embodiment described herein, further including docking the storage case with a user interface device, wherein the user interface device is configured to facilitate the owner consuming the unique content of the at least one media product.

Example 83: The method of authenticating ownership of media, system, or device of any of Examples 1-90 or any other embodiment described herein, wherein the at least one media product is a video game.

Example 84: The method of authenticating ownership of media, system, or device of any of Examples 1-90 or any other embodiment described herein, further including: receiving a ROM file including a digital copy of the video game; and playing the ROM file using an emulator.

Example 85: The method of authenticating ownership of media, system, or device of any of Examples 1-90 or any other embodiment described herein, wherein the emulator is stored on a smartphone, tablet computer, personal computer, or a specialized hardware module.

Example 86: The method of authenticating ownership of media, system, or device of any of Examples 1-90 or any other embodiment described herein, wherein the emulator is accessed through a web browser.

Example 87: The method of authenticating ownership of media, system, or device of any of Examples 1-90 or any other embodiment described herein, wherein generating the unique identification code includes generating a NFT authenticated using a blockchain.

Example 88: The method of authenticating ownership of media, system, or device of any of Examples 1-90 or any other embodiment described herein, further including transmitting the unique identification code to a user interface device through a wired or wireless connection to facilitate the owner consuming the unique content of the at least one media product by using the user interface device.

Example 89: The method of authenticating ownership of media, system, or device of any of Examples 1-90 or any other embodiment described herein, further including storing the unique identification code in a server, and transmitting the unique identification code from the server to the user interface.

Example 90: The method of authenticating ownership of media, system, or device of any of Examples 1-90 or any other embodiment described herein, further including transferring the storage case to a storage vault, and allowing the owner of the at least one media product to access the unique content of the at least one media product without removing the at least one media product from the storage vault.

What is claimed is:

1. A system for authenticating ownership of media, comprising:
a storage case configured to store and protect at least one media product, the at least one media product including unique content;
an identification module associated with the storage case, wherein the identification module stores a unique identification code used to identify the at least one media product and an owner of the at least one media product;
a transmitter associated with the storage case, the transmitter configured to transmit the unique identification code; and
a server configured to communicate with the transmitter to receive the unique identification code,
wherein transmission of the unique identification code to the server is used to authenticate ownership of the at least one media product to allow the owner to access the unique content of the at least one media product without removing the at least one media product from the storage case.

2. The system of claim 1, wherein the storage case includes a rating banner indicative of a quality rating for the at least one media product.

3. The system of claim 1, wherein the identification module includes an NFC chip, an RFID tag, a FPGA, or a NFT.

4. The system of claim 1, wherein the at least one media product is a video game, an audiovisual product, an audio recording, a video recording, a written work, or a comic book.

5. The system of claim 1, wherein the storage case is configured to dock with a user interface device, and wherein the user interface device is configured to facilitate the owner consuming the unique content of the at least one media product.

6. The system of claim 1, wherein the server is a cloud server.

7. The system of claim 1, further including an emulator configured to display the unique content of the at least one media product.

8. The system of claim 7, wherein the emulator is stored on a smartphone, a tablet computer, a personal computer, or a media display assembly.

9. The system of claim 1, further including:
a database of ROM files in communication with the server; and
a user interface including an emulator, the emulator configured to display the unique content of the at least one media product using a ROM file of the ROM files.

10. The system of claim 1, wherein the storage case is configured to communicate with a user interface device through a wired or wireless connection to facilitate the owner consuming the unique content of the at least one media product by using the user interface device.

11. The system of claim 1, further including a receiver configured to receive data at the storage case, wherein the receiver is configured to receive data through a wired or wireless connection.

12. The system of claim 1, further including a port configured to transmit data from the storage case or receive data at the storage case.

13. The system of claim 12, further including a battery arranged about the storage case, wherein the battery is configured to power the storage case.

14. A system for authenticating ownership of media, comprising:
a first storage case configured to store and protect at least one media product, the at least one media product including unique content;
a first identification module associated with the first storage case, wherein the first identification module stores a first unique identification code used to identify the at least one media product and an owner of the at least one media product;
a first transmitter associated with the first storage case, the first transmitter configured to transmit the first unique identification code;
a server configured to communicate with the first transmitter to receive the first unique identification code,
a second storage case configured to store and protect at least one media console, the at least one media console configured to interface with the at least one media product to display the unique content of the at least one media product;
a second identification module associated with the second storage case, wherein the second identification module stores a second unique identification code used to identify the at least one media console and an owner of the at least one media product, wherein the owner of the at least one media product is the same owner as the owner of the at least one media console; and
a second transmitter associated with the second storage case, the second transmitter configured to transmit the second unique identification code;
wherein the server is configured to communicate with the second transmitter to receive the second unique identification code,
wherein transmission of the first unique identification code and the second unique identification code to the server is used to authenticate ownership of the at least one media product and to authenticate ownership of the at least one media console to allow the owner to access the unique content of the at least one media product without removing the at least one media product from the first storage case and without removing the at least one media console from the second storage case.

15. The system of claim 14, wherein the first identification module includes an NFC chip, an RFID tag, a FPGA, or a NFT, and the second identification module includes an NFC chip, an RFID tag, a FPGA, or a NFT.

16. The system of claim 14, wherein the at least one media product is a video game, an audiovisual product, an audio recording, a video recording, a written work, or a comic book.

17. The system of claim 14, wherein the server is a cloud server.

18. The system of claim 14, further including an emulator configured to display the unique content of the at least one media product.

19. The system of claim 14, further including:
a database of ROM files in communication with the server; and
a user interface including an emulator, the emulator configured to display the unique content of the at least one media product using a ROM file of the ROM files.

20. The system of claim 14, further including a user interface device configured to communicate with the server to facilitate the owner consuming the unique content of the at least one media product by using the user interface device.

21. The system of claim 20, wherein the user interface device is in communication with at least one of a controller or a screen to allow the user to interact with the at least one media product.

22. A method of authenticating ownership of media, comprising:
receiving at least one media product, the at least one media product including unique content;
storing the at least one media product in a storage case to protect the at least one media product;
generating a unique identification code identifying an owner of the at least one media product stored in the storage case; and
transmitting the unique identification code to authenticate the owner of the at least one media product stored in the storage case.

23. The method of claim 22, further including:
allowing the owner of the at least one media product to access the unique content of the at least one media product without removing the at least one media product from the storage case.

24. The method of claim 22, further including grading the media product to generate a quality rating for the at least one media product.

25. The method of claim 22, further including displaying the quality rating on the storage case.

26. The method of claim 22, wherein the transmitted unique identification code includes data from an NFC chip, an RFID tag, a FPGA, or a NFT.

27. The method of claim 22, wherein the at least one media product is a video game, an audiovisual product, an audio recording, a video recording, a written work, or a comic book.

28. The method of claim 22, further including docking the storage case with a user interface device, wherein the user interface device is configured to facilitate the owner consuming the unique content of the at least one media product.

29. The method of claim 22, wherein the at least one media product is a video game.

30. The method of claim 29, further including:
receiving a ROM file including a digital copy of the video game; and
playing the ROM file using an emulator.

31. The method of claim 30, wherein the emulator is accessed through a web browser.

32. The method of claim 22, wherein generating the unique identification code includes generating a NFT authenticated using a blockchain.

33. The method of claim 22, further including transmitting the unique identification code to a user interface device through a wired or wireless connection to facilitate the owner consuming the unique content of the at least one media product by using the user interface device.

34. The method of claim 22, further including storing the unique identification code in a server, and transmitting the unique identification code from the server to the user interface.

35. The method of claim 22, further including transferring the storage case to a storage vault, and allowing the owner of the at least one media product to access the unique content of the at least one media product without removing the at least one media product from the storage vault.

36. A method of authenticating ownership of media, comprising:
receiving at least one media product, the at least one media product including unique content;
creating a digitized copy of the at least one media product including the unique content of the at least one media product;
storing the at least one media product in a storage case to protect the at least one media product;
generating a unique identification code identifying an owner of the at least one media product stored in the storage case; and
transmitting the unique identification code to authenticate the owner of the at least one media product stored in the storage case.

37. The method of claim 36, further including:
allowing the owner of the at least one media product to access the digitized copy of the at least one media product without removing the at least one media product from the storage case.

38. The method of claim 36, further including grading the media product to generate a quality rating for the at least one media product.

39. The method of claim 36, further including displaying the quality rating on the storage case.

40. The method of claim 36, wherein the transmitted unique identification code includes data from an NFC chip, an RFID tag, a FPGA, or a NFT.

41. The method of claim 36, wherein the at least one media product is a video game, an audiovisual product, an audio recording, a video recording, a written work, or a comic book.

42. The method of claim 36, further including docking the storage case with a user interface device, wherein the user interface device is configured to facilitate the owner consuming the unique content of the at least one media product.

43. The method of claim 36, wherein the at least one media product is a video game.

44. The method of claim 43, further including:
receiving a ROM file including a digital copy of the video game; and
playing the ROM file using an emulator.

45. The method of claim 44, wherein the emulator is accessed through a web browser.

46. The method of claim 36, wherein generating the unique identification code includes generating a NFT authenticated using a blockchain.

47. The method of claim 36, further including transmitting the unique identification code to a user interface device through a wired or wireless connection to facilitate the owner consuming the unique content of the at least one media product by using the user interface device.

48. The method of claim 36, further including storing the unique identification code in a server, and transmitting the unique identification code from the server to the user interface.

49. The method of claim 36, further including transferring the storage case to a storage vault, and allowing the owner of the at least one media product to access the unique content of the at least one media product without removing the at least one media product from the storage vault.
